(19) United States
(12) Patent Application Publication
(10) Pub. No.: US 2023/0173724 A1
(43) Pub. Date: Jun. 8, 2023

(54) INJECTION MOLDING SYSTEM

(71) Applicant: FANUC CORPORATION, Yamanashi (JP)

(72) Inventors: Tatsuhiro UCHIYAMA, Yamanashi (JP); Satoshi TAKATSUGI, Yamanashi (JP)

(73) Assignee: FANUC CORPORATION, Yamanashi (JP)

(21) Appl. No.: 17/997,229

(22) PCT Filed: May 7, 2021
(86) PCT No.: PCT/JP2021/017496

§ 371 Date: Oct. 26, 2022

(30) Foreign Application Priority Data
May 8, 2020 (JP) 2020-082533

(51) Int. Cl. B29C 45/42; B29C 45/76

(52) U.S. Cl. CPC B29C 45/42; B29C 45/7626; B29C 2045/4266; B29C 2945/76899

(57) ABSTRACT

Provided is an injection molding system that makes it possible to maintain convenience while improving safety. The injection molding system comprises an injection molding machine, a peripheral device used in combination with the injection molding machine, and an operation device that is for operating the injection molding machine and the peripheral device and that can be separated from the injection molding machine and the peripheral device and moved. The operation device includes a first operation part for operating the injection molding machine 2, a second operation part for operating the peripheral device, an operation-permitting part that permits operation of the injection molding machine by the first operation part or operation of the peripheral device by the second operation part, and an operation control unit for controlling operation of the injection molding machine and the peripheral device by the first operation part, the second operation part, and the operation-permitting part.

### TECHNICAL FIELD

The present invention relates to an injection molding system.

### BACKGROUND ART

Conventionally, an injection molding machine has an operation panel that is operated by a worker. For the worker’s ease of operation and safety, the operation panel is normally installed at a position where it is possible to easily observe a movable part and it is possible to secure a safe distance between the movable part and the worker.

Furthermore, such an injection molding machine is also known that has an operation panel that is separated from a main body of the injection molding machine and is thus movable (for example, see Patent Document 1). The operation panel described in Patent Document 1 makes it possible to be shared for operation among those including a machine for taking out molded products and a robot, which are used in combination with the injection molding machine.

Patent Document 1: Japanese Unexamined Patent Application, Publication No. 2005-219332

### DISCLOSURE OF THE INVENTION

### Problems to Be Solved by the Invention

Although the operation panel described in Patent Document 1 offers superior convenience, the worker holding the operation panel can approach the movable part, possibly sacrificing safety. As such, there is demand for an injection molding system that makes it possible to maintain convenience while improving safety.

### Means for Solving the Problems

An injection molding system according to the present disclosure includes an injection molding machine, a peripheral device used in combination with the injection molding machine, and an operation device configured to be movable in a separated manner from the injection molding machine and the peripheral device. The operation device is configured to operate the injection molding machine and the peripheral device. The operation device includes a first operation part configured to operate the injection molding machine, a second operation part configured to operate the peripheral device, an operation-permitting part configured to permit operation of the injection molding machine by the first operation part or operation of the peripheral device by the second operation part, and an operation control unit configured to control operation of the injection molding machine and the peripheral device by the first operation part, the second operation part, and the operation-permitting part.

### Effects of the Invention

According to the present invention, it is possible to maintain convenience while improving safety.

### BRIEF DESCRIPTION OF THE DRAWINGS

FIG. 1 is a view illustrating an outline of an injection molding system according to an embodiment;

FIG. 2 is a view illustrating a functional configuration of an injection molding system according to a first embodiment;

FIG. 3 is a view illustrating a configuration of an operation device according to the first embodiment;

FIG. 4 is a view illustrating a functional configuration of an injection molding system according to a second embodiment; and

FIG. 5 is a view illustrating a configuration of an operation device according to the second embodiment.

### PREFERRED MODE FOR CARRYING OUT THE INVENTION

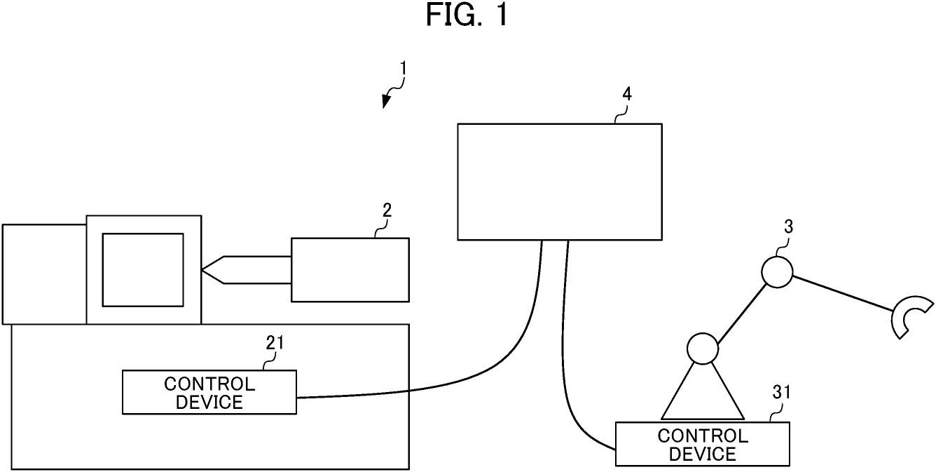

Examples of embodiments of the present invention will now be described herein. FIG. 1 is a view illustrating an outline of an injection molding system 1 according to an embodiment.

The injection molding system 1 includes an injection molding machine 2, a peripheral device 3, and an operation device 4. The injection molding machine 2 is a machine that, for example, injects resin melted at a high temperature into a mold and allows the resin to be cooled to manufacture a product (molded product).

The injection molding machine 2 includes, for example, a mold clamping device that moves a movable platen relative to a fixed platen to open and close the pair of molds to perform mold clamping and an injection device that is provided to the fixed platen in a relatively movable manner by an injection mechanism and that injects a molding material such as melted resin into a cavity in the pair of molds being mold clamped.

The peripheral device 3 is a device used in combination with the injection molding machine 2. The peripheral device 3 is, for example, a robot that removes a molded product manufactured by the injection molding machine 2 from the injection molding machine 2 and that conveys the molded product. Furthermore, the peripheral device 3 may be, for example, a robot that inserts an insert part into a pair of molds or an additional injection device that performs multi-material molding.

The operation device 4 is a device configured to operate the injection molding machine 2 and the peripheral device 3. The operation device 4 is coupled to the injection molding machine 2 and the peripheral device 3 in the form of wired communications or wireless communications, and is configured to be movable in a separated manner from the injection molding machine 2 and the peripheral device 3.

### First Embodiment

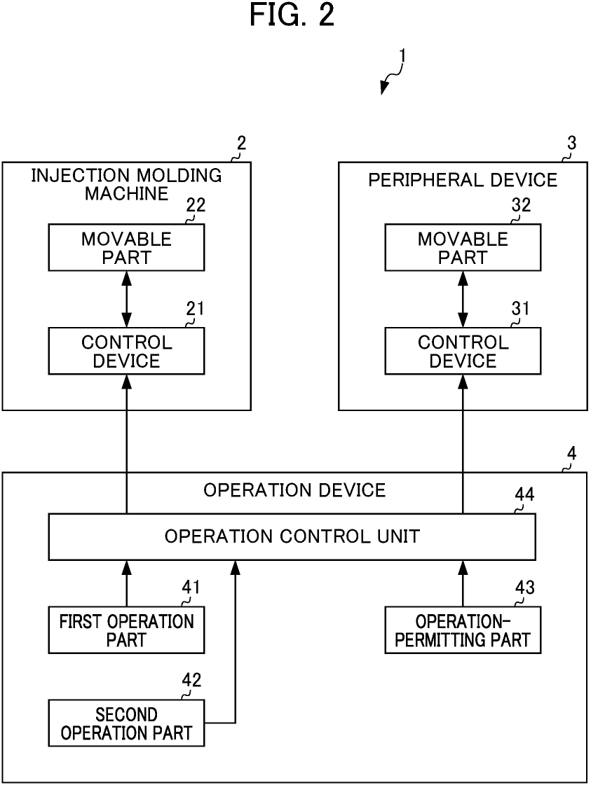

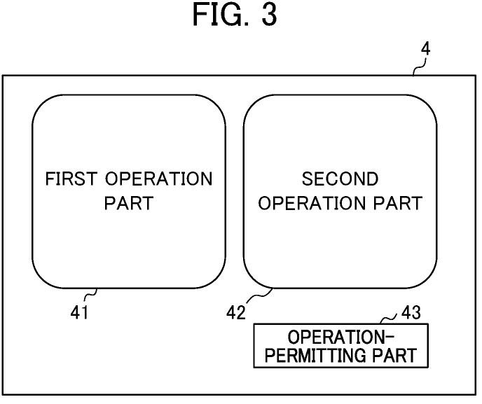

FIG. 2 is a view illustrating a functional configuration of the injection molding system 1 according to a first embodiment. FIG. 3 is a view illustrating a configuration of the operation device 4 according to the first embodiment. As illustrated in FIG. 2, the injection molding machine 2 includes a control device 21 and a movable part 22.

The control device 21 is constructed from a microprocessor and other devices, for example, and is configured to control operation, which varies in type, of the injection molding machine 2. The movable part 22 includes, for example, a mold-clamping mechanism, a projection mechanism, the injection mechanism, an injection device advancing and retracting mechanism, and a mold thickness adjustment mechanism of the injection molding machine 2. Furthermore, the movable part 22 operates under the control of the control device 21.

The peripheral device 3 includes a control device 31 and a movable part 32. The control device 31 is constructed from a microprocessor and other devices, for example, and is configured to control operation, which varies in type, of the peripheral device 3.

When the peripheral device 3 is a robot, the movable part 32 includes an arm and a hand, for example. Furthermore, when the peripheral device 3 is an additional injection device, the movable part 32 includes an injection mechanism and an injection device advancing and retracting mechanism, for example.

The operation device 4 is coupled to the control device 21 and the control device 31, and, when operated by an operator, sends an operation signal to the control device 21 and the control device 31. Thereby, the operator is able to use the operation device 4 to operate the movable part 22 of the injection molding machine 2 and the movable part 32 of the peripheral device 3.

The operation device 4 may include a display part and physical operation keys and/or buttons, or may include a touch panel in which a display part and an operation part are integrated into one piece. Furthermore, the operation device 4 may include both a touch panel and physical operation keys and/or buttons.

The operation device 4 is coupled to the control device 21 of the injection molding machine 2 and the control device 31 of the peripheral device 3 in the form of wired communications or wireless communications. Specifically, in the case of wired communications, the operation device 4 is coupled to the control device 21 and the control device 31 via a communication cable, for example. Furthermore, in the case of wireless communications, the operation device 4 is coupled to the control device 21 and the control device 31 in the form of wireless communications conforming to a wireless communication standard such as Bluetooth (registered trademark) or Wi-Fi.

Furthermore, the operation device 4 includes a first operation part 41, a second operation part 42, an operation-permitting part 43, and an operation control unit 44. The first operation part 41, the second operation part 42, and the operation-permitting part 43 may be, as described above, physical operation keys or buttons, or virtual keys or buttons displayed on a touch panel.

The first operation part 41 is configured to function as an operation board used to operate the injection molding machine 2. For example, as the operator operates the first operation part 41, the operation control unit 44 sends an operation signal to the control device 21 of the injection molding machine 2. Then, the control device 21 follows the operation signal to cause the movable part 22 to operate.

The second operation part 42 is configured to function as an operation board used to operate the peripheral device 3. For example, as the operator operates the second operation part 42, the operation control unit 44 sends an operation signal to the control device 31 of the peripheral device 3. Then, the control device 31 follows the operation signal to cause the movable part 32 to operate.

The operation-permitting part 43 is an operation part configured to permit (only either) operation of the injection molding machine 2 by the first operation part 41 or operation of the peripheral device by the second operation part 42.

The operation control unit 44 is constructed from a microprocessor and other devices, for example, and is configured to control operation of the injection molding machine 2 and the peripheral device 3 by the first operation part 41, the second operation part 42, and the operation-permitting part 43.

As illustrated in FIG. 3, in the first embodiment, the operation device 4 arranges and/or displays the first operation part 41, the second operation part 42, and the operation-permitting part 43 in a simultaneously operable state.

In this state, the operation control unit 44 does not permit operation of the injection molding machine 2 or the peripheral device 3 by the first operation part 41 or the second operation part 42. As such, even when the first operation part 41 or the second operation part 42 is solely operated, the injection molding machine 2 or the peripheral device 3 does not operate.

Then, the operation control unit 44 permits, through simultaneous operation of either the first operation part 41 or the second operation part 42 and the operation-permitting part 43, operation of the injection molding machine 2 or the peripheral device 3.

For example, the operation control unit 44 permits, through simultaneous operation of the first operation part 41 and the operation-permitting part 43, operation of the injection molding machine 2. Thereby, the operator is able to use, for example, the first operation part 41 to operate the movable part 22 of the injection molding machine 2.

Furthermore, the operation control unit 44 permits, through simultaneous operation of the second operation part 42 and the operation-permitting part 43, operation of the injection molding machine 2. Thereby, the operator is able to use, for example, the second operation part 42 to operate the movable part 32 of the peripheral device 3.

As described above, the injection molding system 1 according to the first embodiment includes the injection molding machine 2, the peripheral device 3 used in combination with the injection molding machine, and the operation device 4 configured to be movable in a separated manner from the injection molding machine 2 and the peripheral device 3 and configured to operate the injection molding machine 2 and the peripheral device 3. The operation device 4 includes the first operation part 41 configured to operate the injection molding machine 2, the second operation part 42 configured to operate the peripheral device 3, the operation-permitting part 43 configured to permit operation of the injection molding machine 2 by the first operation part 41 or operation of the peripheral device 3 by the second operation part 42, and the operation control unit 44 configured to control operation of the injection molding machine 2 and the peripheral device 3 by the first operation part 41, the second operation part 42, and the operation-permitting part 43.

Thereby, the injection molding system 1 permits operation of the injection molding machine 2 or operation of the peripheral device 3 by the operation-permitting part 43. As such, the injection molding system 1 is able to maintain convenience for operation of the injection molding machine 2 or the peripheral device 3 by the operation device 4, while preventing the operator from mistakenly operating the injection molding machine 2 or the peripheral device 3. Therefore, the injection molding system 1 makes it possible to maintain convenience for operation of the injection molding machine 2 or the peripheral device 3 while improving safety.

Furthermore, the operation control unit 44 enables, through simultaneous operation of either the first operation part 41 or the second operation part 42 and the operation-permitting part 43, operation of the injection molding machine 2 or the peripheral device 3. Thereby, the injection molding system 1 is not able to operate the injection molding machine 2 or the peripheral device 3 when there is no simultaneous operation of either the first operation part 41 or the second operation part 42 and the operation-permitting part 43. Therefore, the injection molding system 1 makes it possible to prevent the operator from mistakenly operating the injection molding machine 2 or the peripheral device 3.

Furthermore, the peripheral device 3 is a robot that removes a molded product from the injection molding machine 2 and that conveys the molded product. Thereby, the injection molding system 1 makes it possible to maintain convenience for operation of the robot while improving safety.

Furthermore, the operation device 4 is coupled to the injection molding machine 2 and the peripheral device 3 in the form of wired communications or wireless communications. Thereby, the injection molding system 1 makes it possible to appropriately communicably couple the operation device 4, the injection molding machine 2, and the peripheral device 3 to each other.

### Second Embodiment

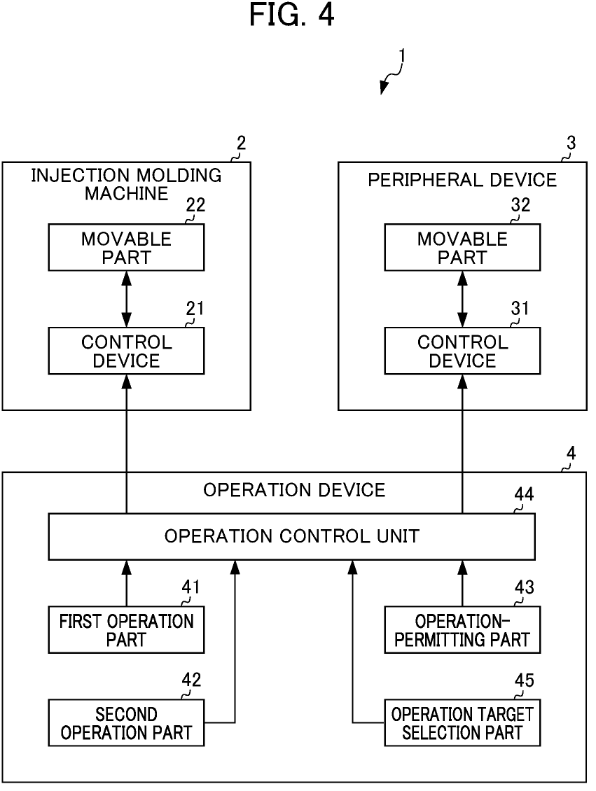

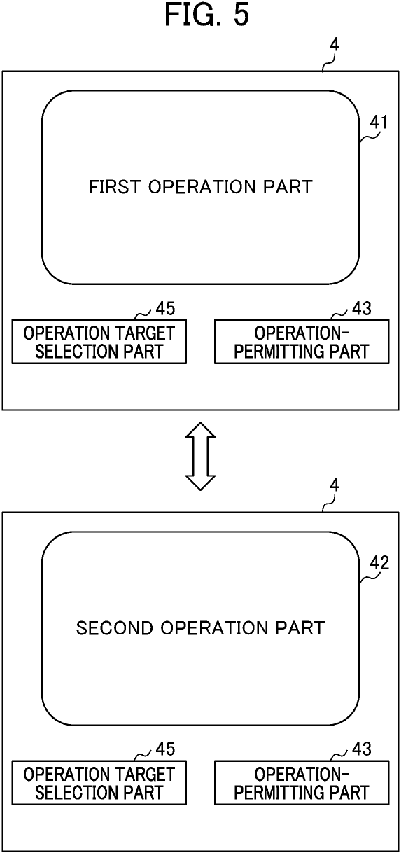

FIG. 4 is a view illustrating a functional configuration of an injection molding system 1 according to a second embodiment. FIG. 5 is a view illustrating a configuration of an operation device 4 according to the second embodiment. Note that, to describe the second embodiment, like reference numerals designate identical or corresponding components in the first embodiment. The description of the components are thus omitted or simplified. The injection molding system 1 according to the second embodiment differs from that according to the first embodiment mainly in that it includes an operation target selection part 45. For other components, however, the injection molding system 1 according to the second embodiment includes components that are similar to those according to the first embodiment, which are illustrated in FIGS. 2 and 3.

As illustrated in FIG. 4, the operation device 4 includes a first operation part 41, a second operation part 42, an operation-permitting part 43, an operation control unit 44, and the operation target selection part 45. The operation target selection part 45 is an operation part configured to select operation of the injection molding machine 2 by the first operation part 41 or operation of the peripheral device 3 by the second operation part 42.

As illustrated in FIG. 5, as the operation target selection part 45 is operated, the operation control unit 44 is able to perform switching to operation of the injection molding machine 2 by the first operation part 41 or operation of the peripheral device 3 by the second operation part 42.

In this state, the operation control unit 44 does not permit operation of the injection molding machine 2 or the peripheral device 3 by the first operation part 41 or the second operation part 42. As such, even when the first operation part 41 or the second operation part 42 is solely operated, the injection molding machine 2 or the peripheral device 3 does not operate. Then, the operation control unit 44 permits, through simultaneous operation of either the first operation part 41 or the second operation part 42 and the operation-permitting part 43, operation of the injection molding machine 2 or the peripheral device 3.

For example, the operation control unit 44 permits, through simultaneous operation of the first operation part 41 and the operation-permitting part 43, operation of the injection molding machine 2. Thereby, the operator is able to use, for example, the first operation part 41 to operate the movable part 22 of the injection molding machine 2.

Furthermore, the operation control unit 44 permits, through simultaneous operation of the second operation part 42 and the operation-permitting part 43, operation of the injection molding machine 2. Thereby, the operator is able to use, for example, the second operation part 42 to operate the movable part 32 of the peripheral device 3.

As described above, the injection molding system 1 according to the second embodiment further includes the operation target selection part 45 configured to select operation of the injection molding machine 2 by the first operation part 41 or operation of the peripheral device 3 by the second operation part 42. Thereby, as the injection molding system 1 is able to select operation of the injection molding machine 2 by the first operation part 41 or operation of the peripheral device 3 by the second operation part 42, it is possible to prevent the operator from mistakenly operating the injection molding machine 2 or the peripheral device 3.

Although the embodiments of the present invention have been described above, it is possible to achieve the injection molding systems described above through hardware, software, or combinations thereof. Furthermore, it is also possible to achieve a control method that is to be implemented through cooperation of respective components for injection molding, as described above, through hardware, software, or combinations thereof. In here, achievement through software means achievement when a computer reads and executes a program.

It is possible to use a non-transitory computer readable medium that varies in type to store the program, and to supply the program to a computer. Examples of the non-transitory computer readable medium include tangible storage media that vary in type. Examples of the non-transitory computer readable medium include magnetic recording media (for example, hard disk drive), magneto-optical recording media (for example, magneto-optical disc), compact disc read only memories (CD-ROM), compact disc-recordable (CD-R), compact disc-rewritable (CD-R/W), semiconductor memories (for example, mask ROM, programmable ROM (PROM), erasable PROM (EPROM), flash ROM, and random access memory (RAM)).

Furthermore, although the foregoing embodiments represent preferable embodiments of the present invention, the scope of the present invention should not be limited to only the embodiments described above. Embodiments that have been variously changed without departing from the gist of the present invention are also implementable.

### EXPLANATION OF REFERENCE NUMERALS

| | |
|---|---|
| 1 | Injection molding system |
| 2 | Injection molding machine |
| 3 | Peripheral device |
| 4 | Operation device |
| 21 | Control device |
| 22 | Movable part |
| 31 | Control device |
| 32 | Movable part |
| 41 | First operation part |
| 42 | Second operation part |
| 43 | Operation-permitting part |
| 44 | Operation control unit |
| 45 | Operation target selection part |

1. An injection molding system comprising:
an injection molding machine;
a peripheral device used in combination with the injection molding machine; and
an operation device configured to be movable in a separated manner from the injection molding machine and the peripheral device, the operation device being configured to operate the injection molding machine and the peripheral device,
the operation device including:
a first operation part configured to operate the injection molding machine;
a second operation part configured to operate the peripheral device;
an operation-permitting part configured to permit operation of the injection molding machine by the first operation part or operation of the peripheral device by the second operation part; and
an operation control unit configured to control operation of the injection molding machine and the peripheral device by the first operation part, the second operation part, and the operation-permitting part.

2. The injection molding system according to claim 1, wherein the operation control unit enables, through simultaneous operation of either the first operation part or the second operation part and the operation-permitting part, operation of the injection molding machine or the peripheral device.

3. The injection molding system according to claim 1, wherein the operation device further includes an operation target selection part configured to select operation of the injection molding machine by the first operation part or operation of the peripheral device by the second operation part.

4. The injection molding system according to claim 1, wherein the peripheral device is a robot that removes a molded product from the injection molding machine and that conveys the molded product.

5. The injection molding system according to claim 1, wherein the operation device is coupled to the injection molding machine and the peripheral device in a form of wired communications or wireless communications.
